(19) United States
(12) Patent Application Publication
(10) Pub. No.: US 2016/0360580 A1
(43) Pub. Date: Dec. 8, 2016

(54) LED DRIVE AND LED LAMP

(71) Applicant: DONGGUAN JIASHENG LIGHTING TECHNOLOGY CO. LTD, Dongguan City (CN)

(72) Inventor: Shuisheng XU, Dongguan City (CN)

(21) Appl. No.: 15/018,627

(22) Filed: Feb. 8, 2016

(30) Foreign Application Priority Data
Jun. 8, 2015 (CN) 201520393655.X

(51) Int. Cl. H05B 33/08; F21V 23/00; F21V 23/06

(52) U.S. Cl. CPC H05B 33/0809; H05B 33/0845; F21V 23/06; F21V 23/003

(57) ABSTRACT

A LED drive and a LED lamp are disclosed. The LED drive includes a body, which is provided with a signal processing module, a data transmission connection port being mounted on the signal processing module, and a jack for a data transmission connection plug inserting into the data transmission connection port is provided on the body; and an intelligent control module, on which the data transmission connection plug is mounted. The plug-type fit mode of the intelligent control module and the body can allow the intelligent control module to be replaceable and customizable, and users can choose whether or not to purchase according to their own need, which is more user-friendly and brings a good user experience.

### CROSS REFERENCE TO RELATED APPLICATIONS

This application claims priority under 35 U.S.C. §119(b) and 37 CFR 1.55 to Chinese application filed on Jun. 8, 2015, and having serial number CN 201520393655.X, wherein the entirety of said application is incorporated herein by reference.

### FIELD

The disclosure relates to the field of drive control, and more particularly, to a LED drive and a LED lamp.

### BACKGROUND

In the '90s the United States put forward the project of “green lighting”. Thereafter, countries around the world have promoted the concept of green lighting to a certain degree, which results in the concept of intelligent lighting. With the development of the Internet of Things, the LED lighting technology gets a booming development due to its own controllability. At present, the intelligence of the LED is implemented by power control, and the intelligent control module is directly integrated into a circuit board inside the driver, and cannot be chosen according to user demand, which increases production costs and users' purchase costs.

### SUMMARY

Based on above, the objective of the present disclosure is to provide a LED drive to overcome the defects of the prior art, which can select the corresponding configuration according to user demand to meet the needs of different clients.

The present disclosure further provides a LED lamp which can select configuration according to user demand to reduce production costs and users' purchase costs.

According to one aspect of the present disclosure, a LED drive is provided, including: a body, in which a signal processing module is provided, a data transmission connection port being mounted on the signal processing module, and a jack for a data transmission connection plug inserting into the data transmission connection port is provided on the body; and an intelligent control module, on which the data transmission connection plug is mounted.

The above technical solution is further described as below.

In one embodiment, the LED drive further includes a plug body configured to house the intelligent control module, and provided with an opening configured to allow the data transmission connection plug to pass through.

In one embodiment, the intelligent control module is a Bluetooth control terminal.

In one embodiment, the data transmission connection port is a USB Port, and the data transmission connection plug is a USB plug fitting the USB Port.

In one embodiment, the LED drive further includes a power convert module coupled to a power supply, and a circuit control module, wherein the power convert module is electrically connected to the circuit control module and the signal processing module, and the circuit control module is also electrically connected to the signal processing module.

According to another aspect of the present disclosure, a LED lamp is provided, including a LED lamp body and the above LED drive, wherein the LED drive is electrically connected to the LED lamp body.

The principles and effects of the above technical solutions are illustrated below.

For the LED drive and the LED lamp, the plug type intelligent control module is connected to the body on which the signal processing module is provided. In this way, the body of the LED drive and the intelligent control module can be manufactured separately without one-to-one correlation, which can improve the manufacturing efficiency of the LED drive. On the other hand, the user can choose the collocation of the intelligent control module and the body of the LED drive according to the need at the time of purchase. This avoids the situation that the intelligent control module is not available to be customized or replaced due to the arrangement of the intelligent control module inside the LED drive in the prior art, which improves the ease and comfort of user effectively with a good user experience.

### BRIEF DESCRIPTION OF THE DRAWINGS

The present disclosure may be best understood by reference to the following description taken in conjunction with the accompanying drawings.

FIG. 1 is a structural schematic diagram illuminating a LED drive according to one embodiment of the present disclosure.

FIG. 2 is an electrical block diagram illuminating a LED drive according to one embodiment of the present disclosure.

Explanation of the reference signs in the drawings:

10 body; 12 jack; 14 data transmission connection plug; 16 plug body; 100 signal processing module; 200 intelligent control module; 300 power convert module; and 400 circuit control module.

### DETAILED DESCRIPTION OF THE PREFERRED EMBODIMENTS

The embodiments of the present disclosure will be described hereinafter with reference to the drawings.

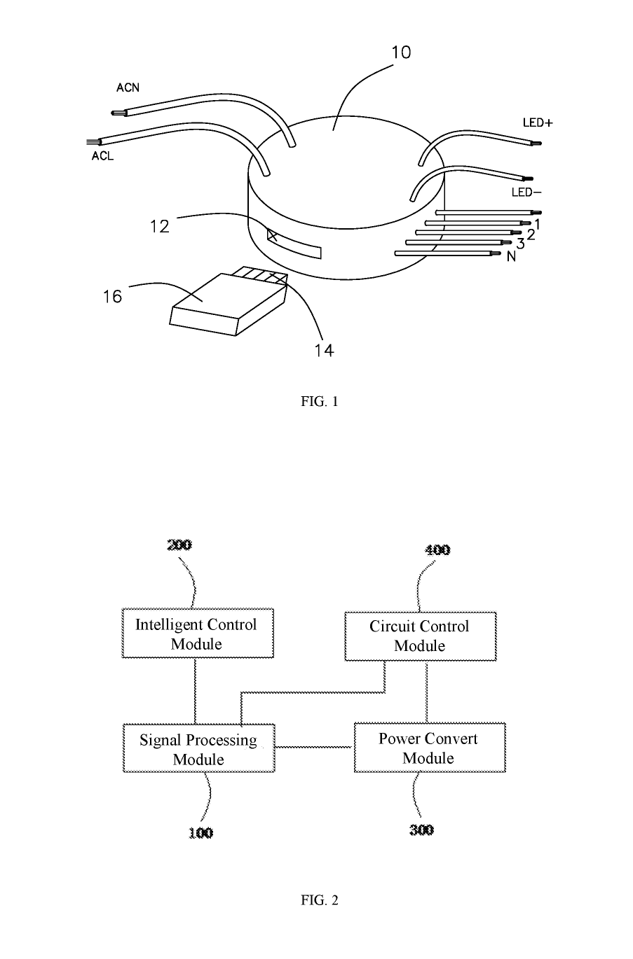

As shown in FIGS. 1-2, a LED drive includes: a body 10, in which a signal processing module 100 is provided. A data transmission connection port (not shown) is mounted on the signal processing module 100, and a jack 12 for a data transmission connection plug 14 inserting into the data transmission connection port is provided on the body 10. The LED drive further includes an intelligent control module 200, on which the data transmission connection plug 14 is mounted.

The intelligent control module 200 and the body of the LED drive are designed as two separate parts. The intelligent control module 200 may be coupled to the signal processing module in the body 10 through the cooperation between the data transmission connection plug 14 and the data transmission connection port. In this way, the signal processing module 100 may receive the instruction from the intelligent control module 200 for corresponding process to achieve the control of the LED. With the fit mode of the intelligent control module 200 and the body 10, the replacement and customization of the intelligent control module 200 can be implemented, and users can choose whether or not to purchase according to their own need, which is more user-friendly and brings a good user experience. Meanwhile, it is compatible with the traditional means.

The intelligent control module 200 is housed inside the plug body 16 which is provided with an opening configured to allow the data transmission connection plug 14 to pass through. The intelligent control module 200 is preferably a Bluetooth control terminal. The user may use an electronic product with a Bluetooth device to send instructions to the intelligent control module 200, and there may be a corresponding response through the action of the signal processing module 100.

In a preferable embodiment, the data transmission connection port is a USB Port, and the data transmission connection plug 14 is a USB plug fitting the USB Port.

As shown in FIG. 2, the LED drive further includes a power convert module 300 and a circuit control module 400. The power convert module 300 is coupled to a power supply, the power convert module 300 is electrically connected to the circuit control module 200 and the signal processing module 100, and the circuit control module 400 is also electrically connected to the signal processing module 100. The power convert module 300 is configured to convert the alternating current into direct current power supply with power of low power consumption. The output end of the power convert module 300 is coupled to power interfaces of the circuit control module 400 and the signal processing module 100 to supply power. The circuit control module 400 is configured to control the switch-on or switch-off of the panel and adjust the current. The circuit control module 400 includes a relay switch, a detection circuit and a light adjustment circuit. The signal processing module 100 is configured to receive instructions from the intelligent control module 200 to control the circuit control module 400 to achieve the switch-on or switch-off of the socket panel and the light adjustment circuit. The light adjustment circuit is configured to adjust the light intensity of the lamp coupled to the panel.

A LED includes a LED lamp body and the above LED drive. The LED drive is electrically connected to the LED lamp body. The LED lamp body can be controlled by the LED drive, and the intelligent control module 200 can cooperate with the electronic product to achieve the intelligent control of the LED lamp body.

Various technical features in the above embodiments can be combined arbitrarily. Not all possible combinations of the technical features in the above embodiments are described herein for the purpose of a brief description. However, it will be understood that the various technical features in the above embodiments can be combined once there is no conflict between these technical features, and such combinations are included within the scope of the disclosed embodiments.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A LED drive, comprising:
a body, which is provided with a signal processing module, a data transmission connection port being mounted on the signal processing module, and a jack for a data transmission connection plug to insert into the data transmission connection port is provided on the body; and
an intelligent control module, on which the data transmission connection plug is mounted.

2. The LED drive of claim 1, further comprising a plug body configured to house the intelligent control module, and provided with an opening configured to allow the data transmission connection plug to pass through.

3. The LED drive of claim 1, wherein the intelligent control module is a Bluetooth control terminal.

4. The LED drive of claim 1, wherein the data transmission connection port is a USB Port, and the data transmission connection plug is a USB plug fitting the USB Port.

5. The LED drive of claim 1, further comprising a power convert module coupled to a power supply, and a circuit control module, wherein the power convert module is electrically connected to the circuit control module and the signal processing module, and the circuit control module is further electrically connected to the signal processing module.

6. A LED lamp, comprising a LED lamp body, wherein the LED lamp further comprises a LED drive of claim 1, and the LED drive is electrically connected to the LED lamp body.
